(19) United States
(12) Patent Application Publication
(10) Pub. No.: US 2026/0085949 A1
(43) Pub. Date: Mar. 26, 2026

(54) MAGNET MOUNT FOR ROBOT ACTUATOR

(71) Applicant: HL Robotics Co., Ltd., Seongnam-si (KR)

(72) Inventor: Jusung LEE, Seongnam-si (KR)

(73) Assignee: HL Robotics Co., Ltd., Seongnam-si (KR)

(21) Appl. No.: 19/331,131

(22) Filed: Sep. 17, 2025

(30) Foreign Application Priority Data
Sep. 26, 2024 (KR) 10-2024-0131156

(51) Int. Cl. G01D 5/14; B25J 19/00

(52) U.S. Cl. CPC G01D 5/145; B25J 19/007

(57) ABSTRACT

A magnet mount for a robot actuator is disclosed. According to an aspect of the present disclosure, the magnet mount includes a cylindrical mount member that is coupled to a lower inner side surface of a plate to rotate and has a hollow; and a magnet member that is attached along a lower outer circumference of the mount member and made of a magnetic material, in which an attachment area to which the magnet member is attached is formed on an outer side of the mount member, and a pattern part having a predetermined pattern is provided in the attachment area.

### CROSS-REFERENCE TO RELATED APPLICATION

This application claims the priority of Korean Patent Application No. 10-2024-0131156 filed on Sep. 26, 2024, in the Korean Intellectual Property Office, the disclosure of which is incorporated herein by reference.

### BACKGROUND

### Field

The present disclosure relates to a magnet mount for a robot actuator, and more particularly, to a magnet mount for a robot actuator in which an attachment area, to which a magnet member is attached, is formed on an outer side of a mount member and a pattern part in the form of a knurling pattern is provided in the attachment area through knurling processing to expand an application area of an adhesive applied to the attachment area, thereby increasing an adhesion between the mount member and the magnet member.

### Description of the Related Art

In general, a robot is a mechanical device that realizes movements, such as catching and carrying, by imitating movements of living creatures such as humans and dogs. Since such robots do not experience muscle fatigue like other living creatures such as humans, the robots may perform high-intensity work for a long time, and therefore, are very suitable for industrial production.

Such robots may generally be configured to include motors, gears, various sensors, motor controllers (ECUs), housings, and other parts.

In addition, a robot actuator is a device that drives a robot to convert electrical energy or fluid energy for generating mechanical displacement or force into mechanical energy. Here, the actuator is a power device that moves a mechanical structure of a robot, and mainly uses hydraulics, motors, etc.

Meanwhile, a sensor may be configured to include a position sensor and a force sensor, and an encoder is generally a fusion sensor that detects a rotation speed or direction of a motor. When such an encoder is used as a position sensor, the encoder may be used to check a rotation speed of a rotor, or to check a rotation speed of an output unit side of a final robot actuator through a gear.

Here, when the output unit of the robot actuator requires precise control, the encoder should also perform precise measurement, and accordingly, it is preferable that the number of poles of a magnet is large.

Since it is advantageous to use an elastic magnet to multi-polarize such a magnet, a magnet made of an elastic material has been widely used.

Meanwhile, a plate to which a mount is coupled is assembled on the output unit side of the robot actuator to rotate according to the rotation of the motor. When the plate rotates, the position of the magnet may be measured by a hall sensor (hall IC) assembled in a housing to confirm the rotation amount.

In general, an adhesive was used to attach a mount and a magnet having magnetism. Therefore, conventionally, when the amount of adhesive applied was excessive, there was a possibility that an adhesive may get on areas other than a bonding area, which may cause poor appearance, and when the magnet was attached, slipping occurred with an outer side surface of the mount, making it difficult to attach the magnet in a correct position. In addition, conventionally, there was a problem that the magnet may separate from the mount due to the rotation and vibration of the actuator when the amount of adhesive applied is excessive.

Conventionally, when the mount was cylindrical, after the magnet was attached to the mount, a lower end portion of the magnet should be aligned with a lower end portion of the mount to prevent detachment during rotation without interference with other parts and lifting, so there was a problem that it is difficult to position the magnet in the correct position.

Accordingly, conventionally, when the magnet was attached to the mount using an instant adhesive, if an application time was long, a hardened section occurred before the entire section was applied, so that the bonding was not properly formed, resulting in poor adhesion or poor bonding.

### RELATED ART DOCUMENT

### Patent Document

(Patent Document 0001) Korean Utility Model Laid-Open Publication No. 20-2020-0000044 (Jan. 6, 2020)

### SUMMARY

An object to be achieved by the present disclosure is to provide a magnet mount for a robot actuator in which an attachment area, to which a magnet member is attached, is formed on an outer side of a mount member and a pattern part in the form of a knurling pattern is provided in the attachment area through knurling processing to expand an application area of an adhesive applied to the attachment area, thereby increasing an adhesion between the mount member and the magnet member.

Another object to be achieved by the present disclosure is to provide a magnet mount for a robot actuator in which an attachment area, to which a magnet member is attached, is formed on an outer side of a mount member and a pattern part in the form of a knurling pattern is provided in the attachment area through knurling processing to prevent slipping due to excessive application of an adhesive when bonding a magnet member to an attachment area, thereby increasing convenience of work.

Another object to be achieved by the present disclosure is to provide a magnet mount for a robot actuator in which a plurality of horizontal grooves and a first protrusion formed between the horizontal grooves are provided in a pattern part of an attachment area which has a magnet member attached thereto and is formed on an outer side of the mount member to expand an application area of an adhesive applied to the attachment area, thereby increasing an adhesion of the mount member and the magnet member.

Another object to be achieved by the present disclosure is to provide a magnet mount for a robot actuator in which a plurality of vertical grooves and a second protrusion formed between the vertical grooves are provided in a pattern part of an attachment area which has a magnet member attached thereto and is formed on an outer side of the mount member to expand an application area of an adhesive applied to the attachment area, thereby increasing an adhesion of the mount member and the magnet member.

Another object to be achieved by the present disclosure is to provide a magnet mount for a robot actuator in which a plurality of horizontal grooves or vertical grooves are provided in a zigzag shape in a pattern part of an attachment area which has a magnet member attached thereto and is formed on an outer side of the mount member to expand an application area of an adhesive applied to the attachment area, thereby more increasing an adhesion of the mount member and the magnet member.

Another object to be achieved by the present disclosure is to provide a magnet mount for a robot actuator in which a guide part formed to protrude outwardly along an outer circumference of a mount member is provided at a lower end of the mount member to prevent an adhesive applied to an attachment area from being released to the outside, thereby improving convenience of work.

Another object to be achieved by the present disclosure is to provide a magnet mount for a robot actuator in which a guide part formed to protrude outwardly along an outer circumference of a mount member is provided at a lower end of the mount member to limit a height of a magnet member attached to an attachment area when bonding the magnet member or to support a lower portion of the magnet member to fix the attached position, thereby improving bonding stability.

The objects of the present disclosure are not limited to the above-mentioned objects. That is, other objects that are not mentioned may be obviously understood by those skilled in the art from the following description.

A magnet mount for a robot actuator according to an exemplary embodiment of the present disclosure that is coupled to a plate that is assembled on an output side of the robot actuator to rotate includes: a cylindrical mount member that is coupled to a lower inner side surface of the plate to rotate and has a hollow; and a magnet member that is attached along a lower outer circumference of the mount member and made of a magnetic material, in which an attachment area to which the magnet member is attached is formed on an outer side of the mount member, and a pattern part having a predetermined pattern is provided in the attachment area.

The mount member may be made of a non-magnetic elastic material.

The magnet member may be made of an elastic material.

A lower end of the mount member may be provided with a guide part that is formed to protrude outwardly along an outer circumference of the mount member.

The guide part may be provided so that a thickness of the guide part protruding outwardly of the mount member is equal to or greater than that of the magnet member.

The pattern part may be provided in the form of a knurling pattern through knurling processing.

The guide part may be provided under the attachment area to support the magnet member attached to the attachment area.

The magnet member may be provided to be attached to the attachment area after applying an adhesive to the attachment area.

The pattern part may include: a plurality of horizontal grooves that is formed at a predetermined interval along a horizontal direction of the mount member, and is formed to be recessed inwardly of the mount member; and a plurality of first protrusions that is formed between the horizontal grooves.

The horizontal groove may be formed in a straight shape having a predetermined thickness along a horizontal direction of the mount member.

The horizontal groove may be formed in a zigzag shape along a horizontal direction of the mount member.

The horizontal groove may be formed at equal vertical intervals, and have an adhesive applied to the attachment area filled therein to attach the magnet member to the attachment area.

The pattern part may include: a plurality of vertical grooves that is formed at a predetermined interval along a vertical direction of the mount member, and is formed to be recessed inwardly of the mount member; and a plurality of second protrusions that is formed between the vertical grooves.

The vertical groove may be formed in a straight shape having a predetermined thickness along a vertical direction of the mount member.

The vertical groove may be formed in a zigzag shape along a vertical direction of the mount member.

The vertical groove may be formed at equal horizontal intervals, and have an adhesive applied to the attachment area filled therein to attach the magnet member to the attachment area.

A rotor assembly of a robot actuator according to another exemplary embodiment of the present disclosure includes: a cylindrical plate that is assembled on an output side of a robot actuator to rotate and has a hollow; a magnet mount that is coupled to the plate; a housing that is installed on a lower outer side surface of the magnet mount; and a hall sensor that is installed above the housing to measure a rotation amount when the magnet mount rotates, in which the magnet mount includes: a cylindrical mount member that is coupled to a lower inner side surface of the plate to rotate and has a hollow; and a magnet member that is attached along a lower outer circumference of the mount member and made of a magnetic material, an attachment area to which the magnet member is attached may be formed on an outer side of the mount member, and a pattern part having a predetermined pattern may be provided in the attachment area.

The hall sensor may be positioned on a side surface of the magnet member and measure a rotation amount of the magnet mount by measuring a position of the magnet member.

A lower end of the mount member may be provided with a guide part that is formed to protrude outwardly along an outer circumference of the mount member.

The pattern part may include: a plurality of horizontal grooves that is formed at a predetermined interval along a horizontal direction of the mount member, and is formed to be recessed inwardly of the mount member; and a plurality of first protrusions that is formed between the horizontal grooves.

The pattern part may include: a plurality of vertical grooves that is formed at a predetermined interval along a vertical direction of the mount member, and is formed to be recessed inwardly of the mount member; and a plurality of second protrusions that is formed between the vertical grooves.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a rotor assembly of a robot actuator according to the present exemplary embodiment;

FIG. 2 is a diagram illustrating an assembled state of a magnet mount for a robot actuator and a plate according to the present exemplary embodiment;

FIG. 3 is a diagram illustrating the magnet mount for a robot actuator according to the present exemplary embodiment;

FIG. 4 is a diagram illustrating a state in which a guide part is added to a mount member in the magnet mount for a robot actuator according to the present exemplary embodiment;

FIG. 5 is a diagram illustrating a pattern part of an attachment area in a magnet mount for a robot actuator according to a first exemplary embodiment of the present disclosure;

FIG. 6 is a diagram illustrating a pattern part of an attachment area in a magnet mount for a robot actuator according to a second exemplary embodiment of the present disclosure;

FIG. 7 is a diagram illustrating a pattern part of an attachment area in a magnet mount for a robot actuator according to a third exemplary embodiment of the present disclosure; and

FIG. 8 is a diagram illustrating a pattern part of an attachment area in a magnet mount for a robot actuator according to a fourth exemplary embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, the present exemplary embodiments will be described in detail with reference to the accompanying drawings. The following exemplary embodiments are presented to sufficiently convey the idea of the present disclosure to those skilled in the art. The present disclosure is not limited only to the exemplary embodiments to be presented below, but may be embodied in other forms. In order to clarify the present disclosure, parts unrelated to the description may be omitted, and a size of components may be slightly exaggerated to aid understanding.

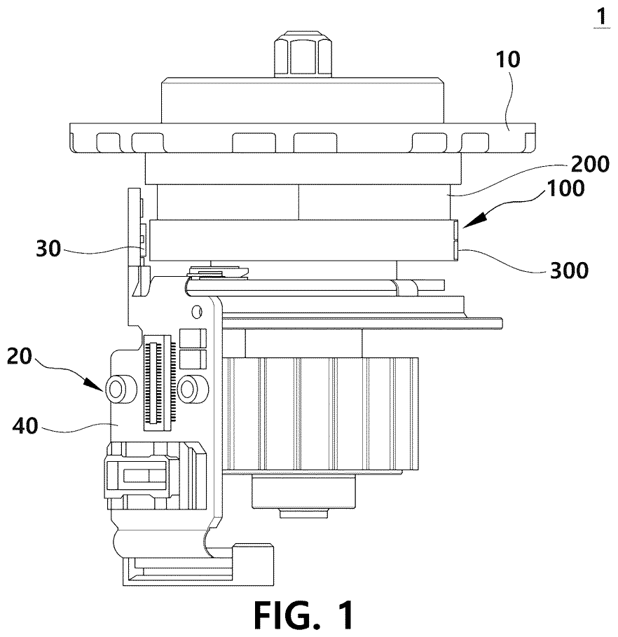

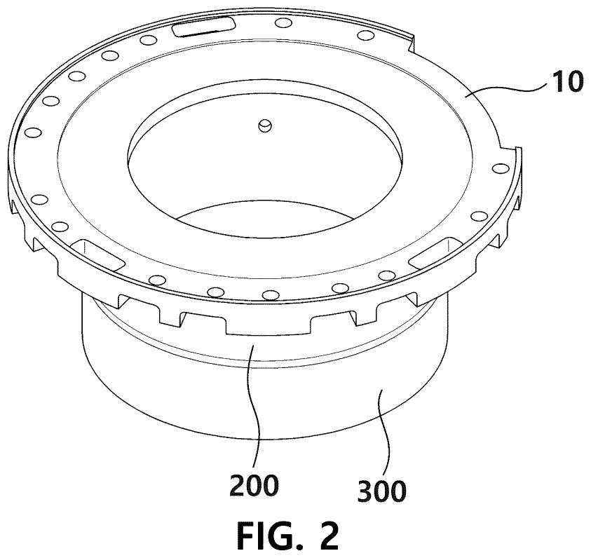

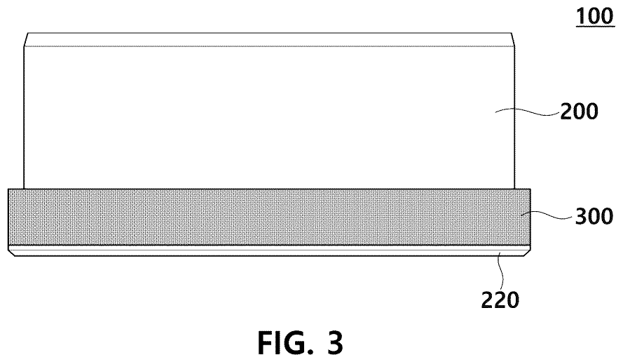

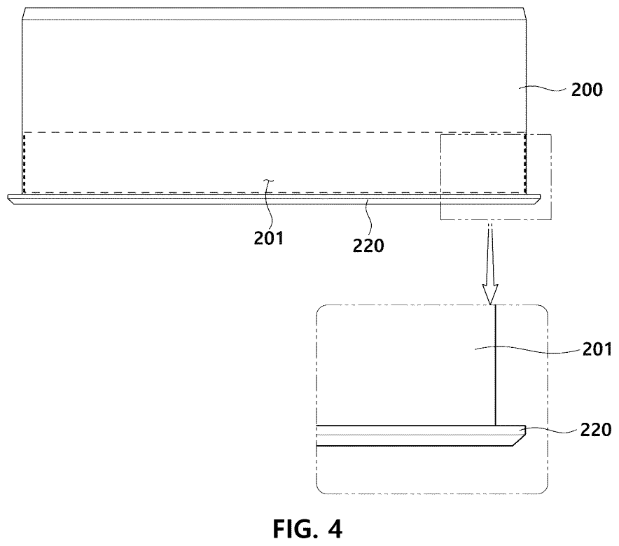

FIG. 1 is a diagram illustrating a rotor assembly 1 of a robot actuator according to the present exemplary embodiment, FIG. 2 is a diagram illustrating an assembled state of a magnet mount 100 for a robot actuator and a plate 10 according to the present exemplary embodiment, FIG. 3 is a diagram illustrating the magnet mount 100 for a robot actuator according to the present exemplary embodiment, and FIG. 4 is a diagram illustrating a state in which a guide part 220 is added to a mount member 200 in the magnet mount 100 for a robot actuator according to the present exemplary embodiment.

Hereinafter, the rotor assembly 1 of the robot actuator according to the present exemplary embodiment will be described with reference to FIG. 1.

According to one aspect of the present disclosure, a rotor assembly 1 of the robot actuator includes a cylindrical plate 10 that is assembled on an output side of the robot actuator to rotate and has a hollow; a magnet mount that is coupled to the plate 10; a housing 20 that is installed on a lower outer side surface of the magnet mount; and a hall sensor 30 that is installed above the housing 20 and measures a rotation amount when the magnet mount rotates, in which the magnet mount includes a cylindrical mount member 200 that is coupled to a lower inner side surface of the plate 10 to rotate and has a hollow; and a magnet member 300 that is attached along a lower outer circumference of the mount member 200 and made of a magnetic material, an attachment area 201 to which the magnet member 300 is attached may be formed on an outer side of the mount member 200 and a pattern part 210 having a predetermined pattern may be formed on the attachment area 201.

The rotor assembly 1 of the robot actuator according to the present exemplary embodiment may be configured to include the plate 10, the magnet mount, the housing 20, and the Hall sensor 30.

The plate 10 may be assembled to the output side of the robot actuator to rotate, and provided in a cylindrical shape having a hollow.

Referring to FIG. 2, the plate 10 may be formed in a shape in which an upper portion, excluding a lower portion to which the mount member 200 is coupled, protrudes outwardly along a circumference. Accordingly, a clutch assembly may be stably coupled to the upper portion of the plate 10.

The magnet mount may be coupled to the plate 10 and may include the mount member 200 and the magnet member 300 attached thereto.

The housing 20 may be configured to be installed on the lower outer side surface of the magnet mount and may include a PCB 40 and a hall sensor 30.

The hall sensor 30 is installed on the upper portion of the housing 20 and is configured to measure a rotation amount when the magnet mount rotates. The hall sensor 30 may be provided in the form of a Hall IC.

In addition, the hall sensor 30 may be provided to be located on the side surface of the magnet member 300 and to measure the rotation amount of the magnet mount by measuring the position of the magnet member 300.

Hereinafter, a magnet mount 100 for a robot actuator according to an exemplary embodiment of the present disclosure will be described with reference to FIGS. 1 to 4.

According to one aspect of the present disclosure, the magnet mount 100 for a robot actuator coupled to the plate 10 that is assembled on the output side of the robot actuator to rotate includes a cylindrical mount member 200 that is coupled to the lower inner side surface of the plate 10 to rotate and has a hollow; and a magnet member 300 that is attached along a lower outer circumference of the mount member 200 and is made of a magnetic material, in which an attachment area 201, to which the magnet member 300 is attached, is formed on an outer side of the mount member 200 and a pattern part 210 having a predetermined pattern is provided in the attachment area 201.

The mount member 200 may be provided to rotate by being coupled to the lower inner side surface of the plate 10 that is assembled to the output side of the robot actuator to rotate.

That is, the mount member 200 may be provided to be coupled to the plate 10 and to be able to rotate together with the rotation of the plate 10, and may be provided in a cylindrical shape having a hollow.

In addition, referring to FIGS. 1 and 2, the mount member 200 may be coupled to an inner side surface of the plate 10 whose upper portion is provided in the cylindrical shape having the hollow and lower portion may be coupled to the plate 10 while protruding toward a lower side of the plate 10.

In addition, the mount member 200 may be made of a non-magnetic elastic material.

In other words, the mount member 200 may be made of a non-magnetic elastic material so as to absorb vibration or shock depending on the implementation.

In other words, the mount member 200 may be provided to absorb some of the vibration or shock that may occur when the plate 10 rotates by coupling the upper portion of the mount member 200 to the plate 10.

In addition, referring to FIG. 4, the attachment area 201 to which the magnet member 300 is attached may be formed on the outer side of the mount member 200. The magnet member 300 may be attached to the lower portion of the mount member 200 along the attachment area 201.

In addition, the pattern part 210 having a predetermined pattern may be provided in the attachment area 201, and the magnet member 300 may be stably attached to the lower portion of the mount member 200 through the pattern part 210.

The magnet member 300 is attached along a lower outer circumference of the mount member 200 and may be made of a magnetic material.

That is, referring to FIG. 1, as the magnet member 300 is attached to the lower portion of the mount member 200, the mount member 200 is coupled between the plate 10 and the magnet member 300, so the plate 10 and the magnet member 300 are disposed at a predetermined interval from each other.

In addition, the magnet member 300 may be made of an elastic material depending on the implementation.

That is, a sensor of the robot actuator may be configured to include a position sensor and a force sensor, and an encoder is generally a fusion sensor that detects a rotation speed or direction of a motor. When such an encoder is used as a position sensor, the encoder may be used to check a rotation speed of a rotor, or to check a rotation speed of an output unit side of a final robot actuator through a gear.

Here, when the output unit of the robot actuator requires precise control, the encoder should also perform precise measurement, and accordingly, it is preferable that the number of poles of the magnet member 300 is large.

Therefore, in order to multi-polarize the magnet member 300, the magnet member 300 is made of an elastic material.

Meanwhile, referring to FIGS. 3 and 4, the guide part 220 may be provided at a lower end of the mount member 200 to protrude outwardly along the outer circumference of the mount member 200.

Accordingly, the guide part 220 may be provided so that a thickness of the guide part 220 protruding outwardly of the mount member 200 is equal to or greater than that of the magnet member 300.

In addition, the guide part 220 may be provided at the lower end of the attachment area 201 to support the magnet member 300 attached to the attachment area 201 of the mount member 200.

That is, the guide part 220 is provided at the lower end of the mount member 200 so that the thickness of the guide part 220 protruding outwardly of the mount member 200 is equal to or greater than that of the magnet member 300, thereby supporting a position of or positioning the magnet member 300 coupled to the upper portion of the guide part 220 in a correct position.

Therefore, since the present disclosure attaches the magnet member 300 to the attachment area 201 while coming into contact with the upper portion of the guide part 220, the attachment position may be easily limited and therefore additional processing process is unnecessary, thereby increasing the process efficiency.

The magnet member 300 may be provided to be attached to the attachment area 201 after applying an adhesive to the attachment area 201.

That is, the present disclosure may be performed by first applying an adhesive or an instant adhesive to the attachment area 201 of the mount member 200, and then attaching the magnet member 300 to the attachment area 201.

Here, the guide part 220 may play a role in preventing the adhesive applied to the attachment area 201 from flowing down and being released to the outside, thereby increasing the convenience of the attachment process.

In this way, according to the magnet mount 100 for a robot actuator of the present disclosure, by providing the guide part 220 on the mount member 200, it is possible to prevent the detachment during rotation without interference with other parts and lifting without a separate process of attaching the magnet member 300 to the mount member 200 and then aligning the lower end portion of the magnet member 300 with the lower end portion of the mount member 200.

According to the magnet mount 100 for a robot actuator of the present disclosure, the guide part 220 formed to protrude outwardly along the outer circumference of the mount member 200 is provided at the lower end of the mount member 200 to prevent the adhesive applied to the attachment area 201 from being released to the outside, thereby improving the convenience of work.

According to the magnet mount 100 for a robot actuator of the present disclosure, the guide part 220 formed to protrude outwardly along the outer circumference of the mount member 200 is provided at the lower end of the mount member 200 to limit the height of the magnet member 300 attached to the attachment area 201 when bonding the magnet member 300 or to support the lower portion of the magnet member 300 to fix the attached position, thereby improving the bonding stability.

Meanwhile, the pattern part 210 formed in the attachment area 201 may be provided in the form of the knurling pattern through the knurling processing.

That is, the pattern part 210 may be provided in the form including a plurality of grooves so as to have the knurling pattern through the knurling processing depending on the implementation, and also be provided in the form of a screw with a repeated pattern.

Conventionally, when attaching the magnet to the outer side surface of the mount, the instant adhesive was used. When using such an instant adhesive, if the application time was long, a hardened section occurred before the entire section was applied, and there was a problem that the bonding was not properly achieved, resulting in poor adhesion or poor adhesion.

However, in the present disclosure, since the pattern part 210 formed in the attachment area 201 is formed in the form of the knurling pattern through the knurling processing, the adhesive may permeate into the inside of the groove formed in a pattern part, thereby providing more time for the bonding process than in the past.

Therefore, in the present disclosure, since the pattern part 210 in the form of the knurling pattern through the knurling processing is formed in the attachment area 201, the application area of the adhesive applied to the attachment area 201 may be expanded and more time for the bonding process time may be secured, thereby having the effect of increasing the adhesion between the mount member 200 and the magnet member 300.

In addition, the present disclosure forms the pattern part 210 in the form of the knurling pattern through the knurling processing in the attachment area 201, thereby preventing slipping due to the excessive application of the adhesive when attaching the magnet member 300 to the attachment area 201, thereby further enhancing the convenience of work.

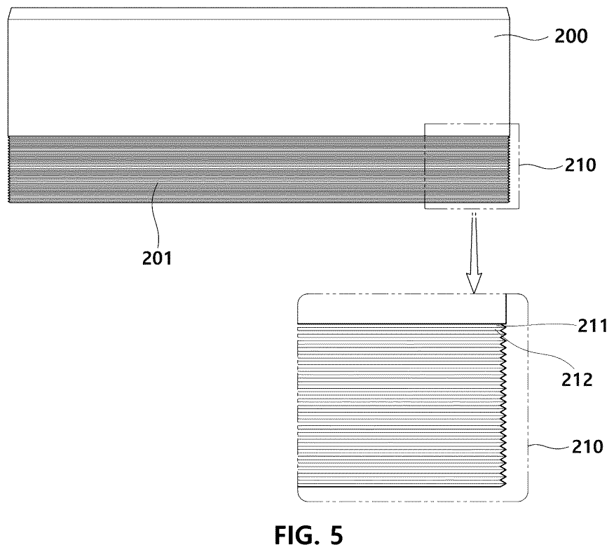

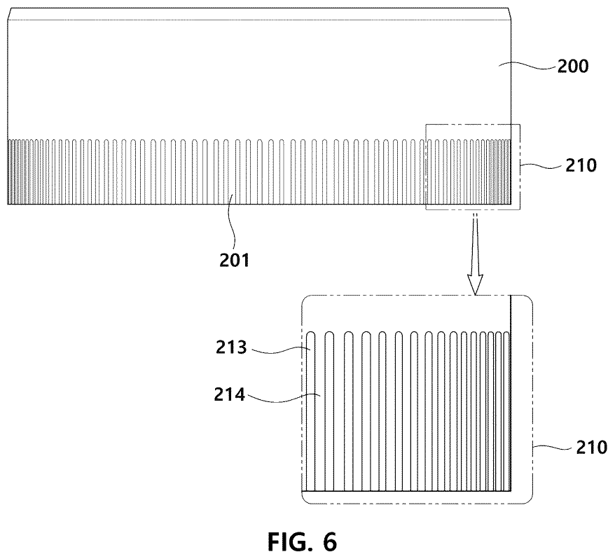

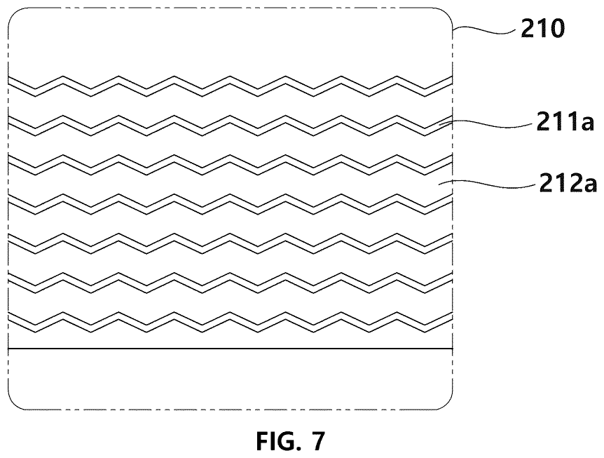

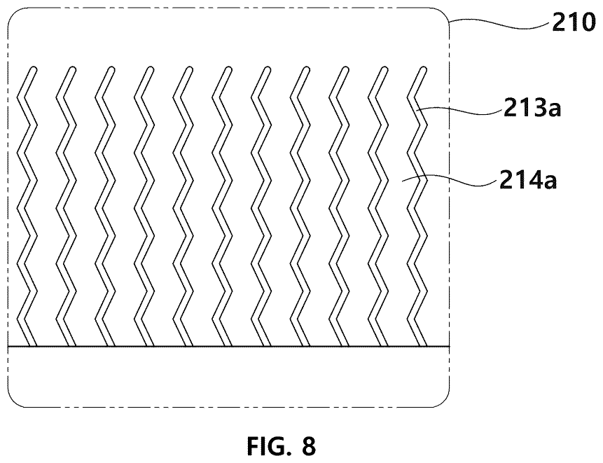

FIG. 5 is a diagram illustrating a pattern part 210 of an attachment area 201 in a magnet mount 100 for a robot actuator according to a first exemplary embodiment of the present disclosure, FIG. 6 is a diagram illustrating a pattern part 210 of an attachment area 201 in a magnet mount 100 for a robot actuator according to a second exemplary embodiment of the present disclosure, FIG. 7 is a diagram illustrating a pattern part 210 of an attachment area 201 in a magnet mount 100 for a robot actuator according to a third exemplary embodiment of the present disclosure, and FIG. 8 is a diagram illustrating a pattern part 210 of an attachment area 201 in a magnet mount 100 for a robot actuator according to a fourth exemplary embodiment of the present disclosure.

Hereinafter, referring to FIGS. 5 to 8, the magnet mount 100 for a robot actuator according to the first to fourth exemplary embodiments of the present disclosure, which varies depending on the shape of the pattern part 210 formed in the attachment area 201 will be described in detail.

First, referring to FIG. 5, the pattern part 210 of the magnet mount 100 for a robot actuator according to the first exemplary embodiment of the present disclosure may include a plurality of horizontal grooves 211 that is formed at a predetermined interval along a horizontal direction of the mount member 200 and formed to be recessed inwardly of the mount member 200, and a plurality of first protrusions 212 formed between the horizontal grooves 211.

That is, the pattern part 210 of the magnet mount 100 for a robot actuator according to the first exemplary embodiment of the present disclosure may be configured to include the horizontal grooves 211 and the first protrusions 212 formed by the horizontal grooves 211.

The horizontal grooves 211 may be formed in a straight shape having a predetermined thickness along the horizontal direction of the mount member 200.

In addition, the horizontal grooves 211 are formed at equal vertical intervals, and the adhesive applied to the attachment area 201 may be filled into the horizontal grooves to attach the magnet member 300 to the attachment area 201.

In addition, the plurality of horizontal grooves 211 may be formed at the same thickness, and when the adhesive is applied to the attachment area 201, the adhesive permeates into the inside of the horizontal grooves 211, so the application area may be expanded and the bonding area between the magnet member 300 made of an elastic material and the attachment area 201 may be expanded.

Therefore, according to the magnet mount 100 for a robot actuator of the first exemplary embodiment of the present disclosure, the pattern part 210 including the horizontal groove 211 and the first protrusion 212 is formed in the attachment area 201, so the application area of the adhesive applied to the attachment area 201 may be expanded and more time for the bonding process may be secured, thereby increasing the adhesion between the mount member 200 and the magnet member 300.

In addition, according to the magnet mount 100 for a robot actuator of the first exemplary embodiment of the present disclosure, the pattern part 210 including the horizontal groove 211 and the first protrusion 212 is formed in the attachment area 201, so the adhesive applied to the attachment area 201 is filled into the horizontal groove 211 to prevent slipping due to the excessive application of the adhesive, thereby further increasing the convenience of work.

In addition, according to the present disclosure, the pattern part 210 of the magnet mount 100 for a robot actuator according to the first exemplary embodiment of the present disclosure is provided to include the first protrusion 212 in the horizontal direction, so it is possible to expect an effect of preventing the magnet member 300 from slipping in the up-down direction or vertical direction when attaching the magnet member 300 to the attachment area 201.

Next, referring to FIG. 6, the pattern part 210 of the magnet mount 100 for a robot actuator according to the second exemplary embodiment of the present disclosure may include a plurality of vertical grooves 213 that is formed at a predetermined interval along a vertical direction of the mount member 200 and formed to be recessed inwardly of the mount member 200, and a plurality of second protrusions 214 formed between the vertical grooves 213.

That is, the pattern part 210 of the magnet mount 100 for a robot actuator according to the second exemplary embodiment of the present disclosure may be configured to include the vertical grooves 213 and the second protrusions 214 formed by the vertical grooves 213.

The vertical grooves 213 may be formed in a straight shape having a predetermined thickness along the vertical direction of the mount member 200.

In addition, the vertical grooves 213 are formed at equal horizontal intervals, and the adhesive applied to the attachment area 201 may be filled into the vertical grooves to attach the magnet member 300 to the attachment area 201.

In addition, the plurality of vertical grooves 213 may be formed at the same thickness, and when the adhesive is applied to the attachment area 201, the adhesive permeates into the inside of the vertical grooves 213, so the application area may be expanded and the bonding area between the magnet member 300 made of an elastic material and the attachment area 201 may be expanded.

Therefore, according to the magnet mount 100 for a robot actuator of the second exemplary embodiment of the present disclosure, the pattern part 210 including the vertical groove 213 and the second protrusion 214 is formed in the attachment area 201, so the application area of the adhesive applied to the attachment area 201 may be expanded and more time for the bonding process may be secured, thereby increasing the adhesion between the mount member 200 and the magnet member 300.

In addition, according to the magnet mount 100 for a robot actuator of the second exemplary embodiment of the present disclosure, the pattern part 210 including the vertical groove 213 and the second protrusion 214 is formed in the attachment area 201, so the adhesive applied to the attachment area 201 is filled into the vertical groove 213 to prevent slipping due to the excessive application of the adhesive, thereby further increasing the convenience of work.

In addition, according to the present disclosure, the pattern part 210 of the magnet mount 100 for a robot actuator according to the second exemplary embodiment of the present disclosure is provided to include the second protrusion 214 in the vertical direction, so it is possible to expect an effect of preventing the magnet member 300 from slipping in the left-right direction or horizontal direction when attaching the magnet member 300 to the attachment area 201.

Next, referring to FIG. 7, the pattern part 210 of the magnet mount 100 for a robot actuator according to the third exemplary embodiment of the present disclosure may include zigzag-shaped horizontal grooves 211a and a plurality of first protrusions 212a formed between the horizontal grooves 211a.

That is, the horizontal groove 211a of the pattern part 210 of the magnet mount 100 for a robot actuator according to the third exemplary embodiment of the present disclosure may be formed in a zigzag shape along the horizontal direction of the mount member 200.

The pattern part 210 may be configured to include the zigzag-shaped horizontal groove 211a and the first protrusion 212a formed by the horizontal groove 211a.

In addition, the zigzag-shaped horizontal grooves 211a are formed at equal vertical intervals, and the adhesive applied to the attachment area 201 may be filled into the horizontal grooves to attach the magnet member 300 to the attachment area 201.

Accordingly, the plurality of zigzag-shaped horizontal grooves 211a may be formed at the same thickness and equal intervals, and when the adhesive is applied to the attachment area 201, the adhesive permeates into the inside of the horizontal grooves 211a, so the application area may be expanded and the bonding area between the magnet member 300 made of an elastic material and the attachment area 201 may be expanded.

Therefore, according to the magnet mount 100 for a robot actuator of the third exemplary embodiment of the present disclosure, the pattern part 210 including the zigzag-shaped horizontal groove 211a and the first protrusion 212a is formed in the attachment area 201, so the application area of the adhesive applied to the attachment area 201 may be expanded and more time for the bonding process may be secured, thereby increasing the adhesion between the mount member 200 and the magnet member 300.

In addition, according to the magnet mount 100 for a robot actuator of the third exemplary embodiment of the present disclosure, the pattern part 210 including the zigzag-shaped horizontal groove 211a and the first protrusion 212a is formed in the attachment area 201, so the adhesive applied to the attachment area 201 is filled into the horizontal groove 211a to prevent slipping due to the excessive application of the adhesive, thereby further increasing the convenience of work.

In addition, according to the present disclosure, the pattern part 210 of the magnet mount 100 for a robot actuator according to the third exemplary embodiment of the present disclosure is provided to include the zigzag-shaped first protrusion 212a in the horizontal direction, so it is possible to expect an effect of preventing the magnet member 300 from slipping in the up-down direction or vertical direction when attaching the magnet member 300 to the attachment area 201.

Next, referring to FIG. 8, the pattern part 210 of the magnet mount 100 for a robot actuator according to the fourth exemplary embodiment of the present disclosure may be configured to include the zigzag-shaped vertical grooves 213a and a second protrusion 214a formed by the vertical grooves 213a.

That is, the vertical groove 213a of the pattern part 210 of the magnet mount 100 for a robot actuator according to the fourth exemplary embodiment of the present disclosure may be formed in the zigzag shape along the vertical direction of the mount member 200.

In addition, the zigzag-shaped vertical grooves 213a are formed at equal horizontal intervals, and the adhesive applied to the attachment area 201 may be filled in the vertical grooves to attach the magnet member 300 to the attachment area 201.

In addition, the plurality of zigzag-shaped vertical grooves 213a may be formed at the same thickness, and when the adhesive is applied to the attachment area 201, the adhesive permeates into the inside of the vertical grooves 213a, so the application area may be expanded and the bonding area between the magnet member 300 made of an elastic material and the attachment area 201 may be expanded.

Therefore, according to the magnet mount 100 for a robot actuator of the fourth exemplary embodiment of the present disclosure, the pattern part 210 including the vertical groove 213a and the second protrusion 214a is formed in the attachment area 201, so the application area of the adhesive applied to the attachment area 201 may be expanded and more time for the bonding process may be secured, thereby increasing the adhesion between the mount member 200 and the magnet member 300.

In addition, according to the magnet mount 100 for a robot actuator of the fourth exemplary embodiment of the present disclosure, the pattern part 210 including the vertical groove 213a and the second protrusion 214a is formed in the attachment area 201, so the adhesive applied to the attachment area 201 is filled into the vertical groove 213a to prevent slipping due to the excessive application of the adhesive, thereby further increasing the convenience of work.

In addition, according to the present disclosure, the pattern part 210 of the magnet mount 100 for a robot actuator according to the fourth exemplary embodiment of the present disclosure is provided to include the second protrusion 214a in the vertical direction, so it is possible to expect an effect of preventing the magnet member 300 from slipping in the left-right direction or horizontal direction when attaching the magnet member 300 to the attachment area 201.

Additionally, according to the present disclosure, the pattern part 210 of the magnet mount 100 for a robot actuator may be provided including the horizontal groove 211 or the vertical groove 212 formed in an “X” shape by being recessed inwardly of the mount member 200 depending on the implementation.

Therefore, in the present disclosure, since when the adhesive is applied to the attachment area 201, the adhesive permeates into the inside of the horizontal groove 211 or vertical groove 212 formed in the X shape, the application area of the adhesive applied to the attachment area 201 may be expanded and more time for the bonding process time may be secured, thereby having the effect of increasing the adhesion between the mount member 200 and the magnet member 300.

So far, specific exemplary embodiments of the magnet mount 100 for a robot actuator according to the present disclosure have been described, but it is obvious that various modifications are possible without departing from the scope of the present disclosure.

According to the magnet mount for a robot actuator of the present disclosure, the attachment area, to which the magnet member is attached, is formed on the outer side of the mount member and the pattern part in the form of the knurling pattern is provided in the attachment area through the knurling processing to expand the application area of the adhesive applied to the attachment area, thereby increasing the adhesion between the mount member and the magnet member.

According to the magnet mount for a robot actuator of the present disclosure, the attachment area, to which the magnet member is attached, is formed on the outer side of the mount member and the pattern part in the form of the knurling pattern is provided in the attachment area through the knurling processing to prevent slipping due to the excessive application of the adhesive when bonding the magnet member to the attachment area, thereby increasing the convenience of work.

According to the magnet mount for a robot actuator of the present disclosure, the plurality of horizontal grooves and the first protrusion formed between the horizontal grooves are provided in the pattern part of the attachment area which has the magnet member attached thereto and is formed on the outer side of the mount member to expand the application area of the adhesive applied to the attachment area, thereby increasing the adhesion between the mount member and the magnet member.

According to the magnet mount for a robot actuator of the present disclosure, the plurality of vertical grooves and the second protrusion formed between the vertical grooves are provided in the pattern part of the attachment area which has the magnet member attached thereto and is formed on the outer side of the mount member to expand the application area of the adhesive applied to the attachment area, thereby increasing the adhesion between the mount member and the magnet member.

According to the magnet mount for a robot actuator of the present disclosure, the plurality of horizontal grooves or vertical grooves and the first protrusion formed between the horizontal grooves are formed in the zigzag shape on the pattern part of the attachment area which has the magnet member attached thereto and is formed on the outer side of the mount member to expand the application area of the adhesive applied to the attachment area, thereby more increasing the adhesion between the mount member and the magnet member.

According to the magnet mount for a robot actuator of the present disclosure, the guide part formed to protrude outwardly along an outer circumference of the mount member is provided at the lower end of the mount member to prevent the adhesive applied to the attachment area from being released to the outside, thereby improving convenience of work.

According to the magnet mount for a robot actuator of the present disclosure, the guide part formed to protrude outwardly along the outer circumference of the mount member is provided at the lower end of the mount member to limit the height of the magnet member attached to the attachment area when bonding the magnet member or to support the lower portion of the magnet member to fix the attached position, thereby improving bonding stability.

The effects of the present disclosure are not limited to the effects described above, and other effects that are not mentioned may be obviously understood from the following description.

Accordingly, the scope of the present disclosure is not construed as being limited to the described exemplary embodiments but is defined by the appended claims as well as equivalents thereto.

That is, it is to be understood that the exemplary embodiment described above is not restrictive, but is illustrative in all aspects, the scope of the present disclosure is defined by the claims to be provided below rather than the detailed description, and it is to be understood that all the modifications or alterations deriving from the meaning and the scope of the claims and equivalents thereto fall within the scope of the present disclosure.

What is claimed is:

1. A magnet mount for a robot actuator coupled to a plate that is assembled on an output side of the robot actuator to rotate, the magnet mount comprising:
a cylindrical mount member that is coupled to a lower inner side surface of the plate to rotate and has a hollow; and
a magnet member that is attached along a lower outer circumference of the mount member and made of a magnetic material,
wherein an attachment area to which the magnet member is attached is formed on an outer side of the mount member, and
a pattern part having a predetermined pattern is provided in the attachment area.

2. The magnet mount of claim 1, wherein the mount member is made of a non-magnetic elastic material.

3. The magnet mount of claim 1, wherein a lower end of the mount member is provided with a guide part that is formed to protrude outwardly along an outer circumference of the mount member.

4. The magnet mount of claim 3, wherein the guide part is provided so that a thickness of the guide part protruding outwardly of the mount member is equal to or greater than that of the magnet member.

5. The magnet mount of claim 3, wherein the guide part is provided under the attachment area to support the magnet member attached to the attachment area.

6. The magnet mount of claim 1, wherein the magnet member is provided to be attached to the attachment area after applying an adhesive to the attachment area.

7. The magnet mount of claim 1, wherein the pattern part is provided in a form of a knurling pattern through knurling processing.

8. The magnet mount of claim 1, wherein the pattern part includes:
a plurality of horizontal grooves that is formed at a predetermined interval along a horizontal direction of the mount member, and is formed to be recessed inwardly of the mount member; and
a plurality of first protrusions that is formed between the horizontal grooves.

9. The magnet mount of claim 8, wherein the horizontal groove is formed in a straight shape having a predetermined thickness along the horizontal direction of the mount member.

10. The magnet mount of claim 8, wherein the horizontal groove is formed in a zigzag shape along the horizontal direction of the mount member.

11. The magnet mount of claim 8, wherein the horizontal groove is formed at equal vertical intervals, and has an adhesive applied to the attachment area filled therein to attach the magnet member to the attachment area.

12. The magnet mount of claim 1, wherein the pattern part includes:
a plurality of vertical grooves that is formed at a predetermined interval along a vertical direction of the mount member, and is formed to be recessed inwardly of the mount member; and
a plurality of second protrusions that is formed between the vertical grooves.

13. The magnet mount of claim 12, wherein the vertical groove is formed in a straight shape having a predetermined thickness along the vertical direction of the mount member.

14. The magnet mount of claim 12, wherein the vertical groove is formed in a zigzag shape along the vertical direction of the mount member.

15. The magnet mount of claim 12, wherein the vertical groove is formed at equal horizontal intervals, and has an adhesive applied to the attachment area filled therein to attach the magnet member to the attachment area.

16. A rotor assembly of a robot actuator, comprising:
a cylindrical plate that is assembled on an output side of a robot actuator to rotate and has a hollow;
a magnet mount that is coupled to the plate;
a housing that is installed on a lower outer side surface of the magnet mount; and
a hall sensor that is installed above the housing to measure a rotation amount when the magnet mount rotates,
wherein the magnet mount includes:
a cylindrical mount member that is coupled to a lower inner side surface of the plate to rotate and has a hollow; and
a magnet member that is attached along a lower outer circumference of the mount member and made of a magnetic material,
an attachment area to which the magnet member is attached is formed on an outer side of the mount member, and
a pattern part having a predetermined pattern is provided in the attachment area.

17. The robot assembly of claim 16, wherein the hall sensor is positioned on a side surface of the magnet member and measures a rotation amount of the magnet mount by measuring a position of the magnet member.

18. The robot assembly of claim 16, wherein a lower end of the mount member is provided with a guide part that is formed to protrude outwardly along an outer circumference of the mount member.

19. The robot assembly of claim 16, wherein the pattern part includes:
a plurality of horizontal grooves that is formed at a predetermined interval along a horizontal direction of the mount member, and is formed to be recessed inwardly of the mount member; and
a plurality of first protrusions that is formed between the horizontal grooves.

20. The robot assembly of claim 16, wherein the pattern part includes:
a plurality of vertical grooves that is formed at a predetermined interval along a vertical direction of the mount member, and is formed to be recessed inwardly of the mount member; and
a plurality of second protrusions that is formed between the vertical grooves.
